(19) United States
(12) Patent Application Publication
(10) Pub. No.: US 2025/0252424 A1
(43) Pub. Date: Aug. 7, 2025

(54) USER IDENTITY GENERATION AND ACCOUNT PROCESSING SYSTEMS AND METHODS

(71) Applicant: MASTERCARD ASIA/PACIFIC PTE. LTD., SINGAPORE (SG)

(72) Inventors: Jinjing Jiang, Singapore (SG); Dendy Gunawan, Singapore (SG); Rasika Chandana Karunapala, Singapore (SG)

(21) Appl. No.: 18/977,352

(22) Filed: Dec. 11, 2024

(30) Foreign Application Priority Data
Feb. 5, 2024 (SG) 10202400319Y

(51) Int. Cl. G06Q 20/34

(52) U.S. Cl. CPC G06Q 20/34

(57) ABSTRACT

Systems and methods which generate and use user identities are described. A user account processing method comprises: receiving a connection request from a user device, the connection request comprising a user identifier of a user, a subscriber identity module number associated with the user, and a device identifier of a device associated with the user; sending a user identity generation request to a user identity management server; receiving a user identity for the user from the user identity management server; requesting payment card details associated with the user identity from a payment card management system; receiving payment card details associated with the user identity from the payment card management system; generating a payment request comprising the payment card details associated with the user identity; and receiving payment confirmation in response to the payment request.

### CROSS-REFERENCE TO RELATED APPLICATION

This application claims the benefit of, and priority to, Singapore patent application Ser. No. 10202400319Y filed on Feb. 5, 2024. The entire disclosure of the above application is incorporated herein by reference.

### FIELD

The present disclosure relates to the generation of user identities and to account processing methods such as in store shopping using the generated user identities.

### BACKGROUND

This section provides background information related to the present disclosure which is not necessarily prior art.

While there has been significant growth in recent years in online shopping, shopping in physical stores still makes up a large proportion of sales in certain areas, such as grocery shopping. Physical stores will be still in favor for business as many supermarket chains are struggling to make a sizeable profit from online sales. One advantage that on-line shopping has over shopping in physical stores is that in an online environment, customers generally only have to log in once, and following the initial log in, the retailer can retrieve customer details such as previous shopping history, loyalty program membership and other information. In addition, following log in, many online retailers can also retrieve customer payment card details. This can provide an improved customer experience with less friction and an easy checkout flow. In contrast in many physical store environments, customers often only provide details such as loyalty program membership at checkout and this is often provided separately from the customer payment card details.

### SUMMARY

This section provides a general summary of the disclosure, and is not a comprehensive disclosure of its full scope or all of its features. Aspects and embodiments of the disclosure are set out in the accompanying claims.

In accordance with a first aspect of the present invention, a user account processing system is provided. The system comprises: a processor, and a data storage device, data storage device storing computer program instructions operable to cause the processor to: receive a connection request from a user device, the connection request comprising a user identifier of a user, a subscriber identity module number associated with the user, and a device identifier of a device associated with the user; send a user identity generation request to a user identity management server; receive a user identity for the user from the user identity management server; request payment card details associated with the user identity from a payment card management system; receive payment card details associated with the user identity from the payment card management system; generate a payment request comprising the payment card details associated with the user identity; and receive payment confirmation in response to the payment request.

The user identifier of the user may be a mobile telephone number associated with the user. The device identifier of the device associated with the user may be an international mobile equipment identity number of the device associated with the user.

In an embodiment, the data storage device further stores instructions operable to cause the processor to receive an indication of a location of the user device within a merchant premise and wherein the payment request is generated in response to the location being in proximity to a checkout location or area.

In an embodiment, the data storage device further stores instructions operable to cause the processor to identify a user merchant account associated with the user from the user identity.

In an embodiment, the data storage device further stores instructions operable to cause the processor to associate a user merchant account with the user identity.

In an embodiment, data storage device further stores instructions operable to cause the processor to associate a user merchant account with the user identity by associating an existing user merchant account with the user identity.

In an embodiment, the data storage device further stores instructions operable to cause the processor to associate a user merchant account with the user identity by generating a new user merchant account.

According to a second aspect of the present disclosure, a user identity generation system is provided. The user identity generation system comprises: a processor, and a data storage device, data storage device storing computer program instructions operable to cause the processor to: receive a user identity generation request from a requestor server, the user identity generation request comprising a user identifier of a user, a subscriber identity module number associated with the user, and a device identifier of a device associated with the user; generate a user identity for the user as a combination function of the user identifier of the user, the subscriber identity module number associated with the user, and the device identifier of the device associated with the user; and send the user identity for the user to the requestor server.

The user identifier of the user may be a mobile telephone number associated with the user. The device identifier of the device associated with the user may be an international mobile equipment identity number of the device associated with the user.

The combination function may be a hash function.

According to a third aspect of the present disclosure, a user account processing method is provided. The user account processing method comprises: receiving a connection request from a user device, the connection request comprising a user identifier of a user, a subscriber identity module number associated with the user, and a device identifier of a device associated with the user; sending a user identity generation request to a user identity management server; receiving a user identity for the user from the user identity management server; requesting payment card details associated with the user identity from a payment card management system; receiving payment card details associated with the user identity from the payment card management system; generating a payment request comprising the payment card details associated with the user identity; and receiving payment confirmation in response to the payment request.

In an embodiment, the method further comprises identifying a user merchant account associated with the user from the user identity.

In an embodiment, the method further comprises associating a user merchant account with the user identity.

According to a fourth aspect of the present disclosure, a user identity generation method is provided. The user identity generation method comprises: receiving a user identity generation request from a requestor server, the user identity generation request comprising a user identifier of a user, a subscriber identity module number associated with the user, and a device identifier of a device associated with the user; generating a user identity for the user as a combination function of the user identifier of the user, the subscriber identity module number associated with the user, and the device identifier of the device associated with the user; and sending the user identity for the user to the requestor server.

In an embodiment, the combination function is a hash function.

In an embodiment, the user identifier of a user comprises a mobile telephone number associated with the user.

In an embodiment, the device identifier of the device associated with the user comprises an international mobile equipment identity number of the device associated with the user.

Embodiments of the invention may be provided as a network of communicating devices (i.e. a “computerized network”). Embodiments of the invention may be also provided as a software application downloadable into a computer device to facilitate the method. The software application may be a computer program product, which may be stored on a non-transitory computer-readable medium on a tangible data-storage device (such as a storage device of a server, or one within a user device).

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure. In the following, embodiments of the present invention will be described as non-limiting examples with reference to the accompanying drawings in which:

FIG. 1 is a block diagram showing an overview of a merchant premise and user identity processing system according to an embodiment of the present invention;

FIG. 2 is a block diagram showing functional modules of a merchant server according to an embodiment of the present invention;

FIG. 3 a block diagram showing functional modules of a user identity management server according to an embodiment of the present invention;

FIG. 4 is a message flow diagrams showing a user account processing method according to embodiments of the present invention;

FIG. 5 is a flow chart showing a user account processing method according to embodiments of the present invention;

FIG. 6 is a flow chart showing a user identity generation method according to an embodiment of the present invention;

FIG. 7 is a block diagram showing a technical architecture of a merchant server according to an embodiment of the present invention; and

FIG. 8 is a block diagram showing a technical architecture of a user identity management server according to an embodiment of the present invention.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

As used herein, the term “payment card” refers to any cashless payment device associated with a payment account, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers. In addition, the “payment card” may exist as application-based stored value accounts associated with an electronic wallet service provider tied in with an issuer institution.

The term “institution” is used in a sense which is not necessarily limited to organizations which are legally constituted as banks, since in some jurisdictions other organizations may be permitted to maintain financial accounts such as a payment card account. An institution may be one of the following: a bank, a financial technology company, a telecommunication company or a financial institution.

As used in this disclosure, the terms “component,” “module,” “system,” “apparatus,” “interface,” or the like are generally intended to refer to a computer-related entity, either hardware, a combination of hardware and software, software, or software in execution. For example, a component or a module may be, but is not limited to being, a process running on a processor, a processor, an object, an executable, a thread of execution, a program, and/or a computer. By way of illustration, both an application running on a controller and the controller can be a component or a module. One or more components/modules may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

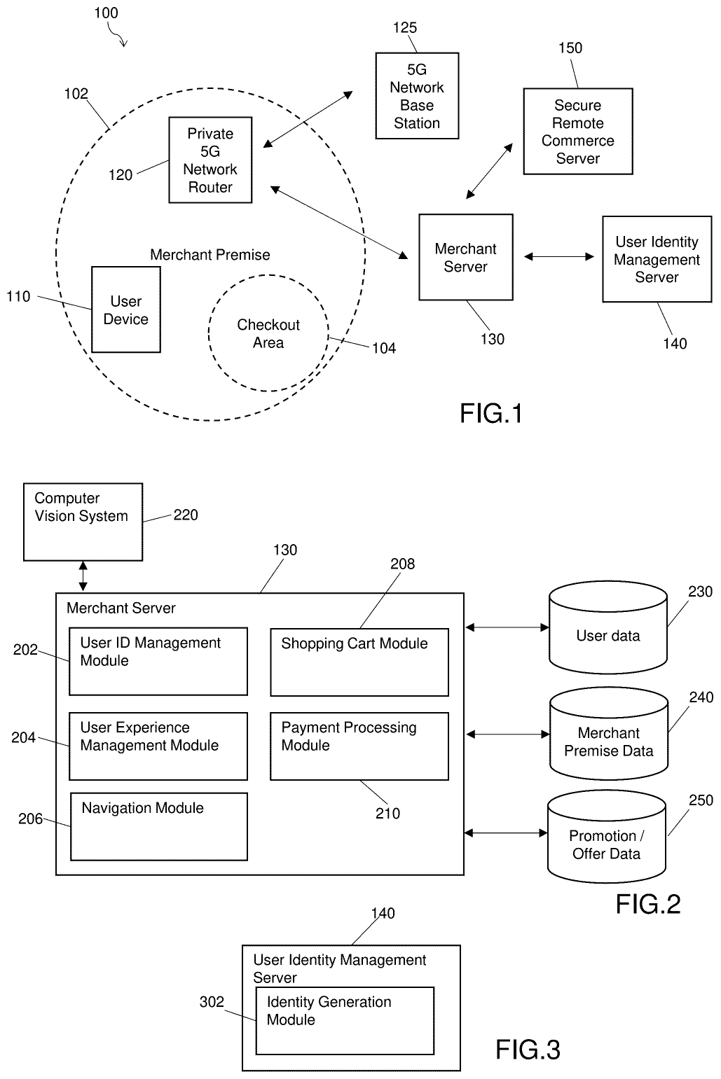

FIG. 1 is a block diagram showing an overview of a merchant premise and user identity processing system according to an embodiment of the present invention. As shown in FIG. 1, the system 100 comprises a retail premise 102. The retail premise 102 may be for example a supermarket which sells a variety of different items, and the items may be located on shelves arranged in aisles within the merchant premise 102. In some embodiments, the merchant premise 102 may be a so called “checkout free” store in which a computer vision system monitors customers as they browse and automatically identifies items placed in their shopping trolley or basket. The merchant premise 102 comprises a checkout area 104. The checkout area 104 may be an exit area of the merchant premise 102 if the merchant premise 102 is a “checkout free” store, a checkout process may automatically commence upon detection of a customer entering the checkout area 104. Alternatively, the checkout area 104 may be a self-checkout area including a scanner to allow the customer to scan items in their shopping trolley or basket.

As shown in FIG. 1, a private 5G network router 120 is located in the merchant premise 102 and a user device 110 associated with the private 5G network router 120. The present disclosure makes use of functionalities of 5G networks such as determination of the location of the user device 110 within the merchant premise 102. This allows the customer experience of shopping at the merchant premise to be improved, for example by providing addition information to the customer based on their location or to guide the customer to the location of desired products. In order to provide such information, it is necessary to be able to identify a customer and embodiments of the present disclosure provide for seamless customer account management as described in more detail below.

As shown in FIG. 1, the private 5G network router 120 is connected to a 5G network base station 125. This connection may allow the user device 110 to connect to the internet through the 5G network. In addition, the private 5G network router 120 is connected to a merchant server 130. The merchant server 130 is connected to a user identity management server 140 and a secure remote commerce server 150.

As will be described in more detail below, the merchant server 130 communicates with the user identity management server 140 to generate a user identity for the customer associated with the user device 110 and this user identity can be used for both account management and payment processing for the customer.

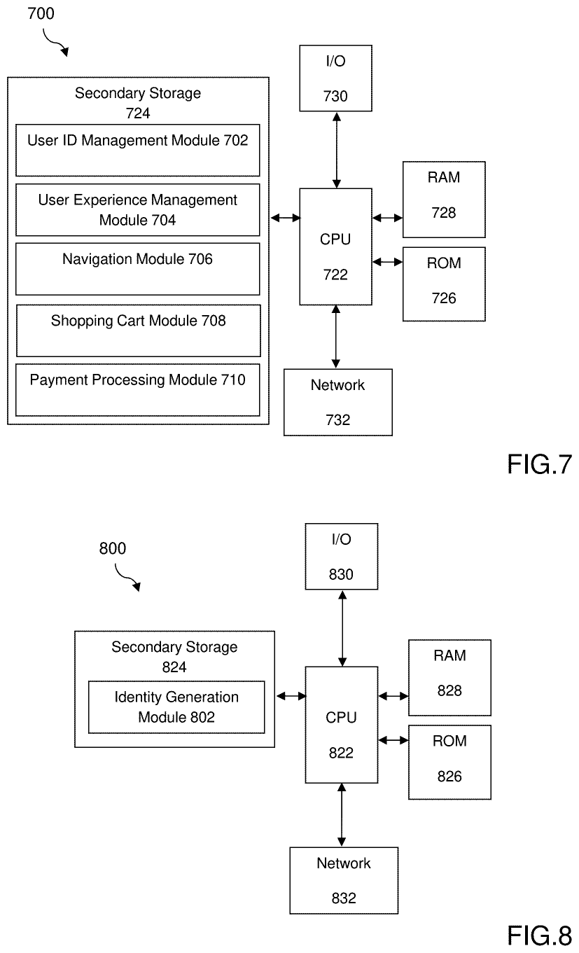

FIG. 2 is a block diagram showing functional modules of a merchant server according to an embodiment of the present invention. As shown in FIG. 2, the merchant server 130 comprises a user ID management module 202, a user experience management module 204, a navigation module 506, a shopping cart module 208 and a payment processing module 210. Each of the modules shown in FIG. 2 may be implemented as hardware, software or a combination of hardware and software. An example of a technical architecture of the merchant server 130 is described in detail below with reference to FIG. 7. The merchant server 130 is coupled to computer vision system 220, a database storing user data 230, a database storing merchant premise data 240 and a database string promotion/offer data 250.

The user ID management module 202 is operable to communicate with the user identity management server 140 to generate a user identity for a customer associated with the user device 110. The user experience management module 204 is operable to communicate with the user device 110 to manage the user experience while the customer is in the merchant premise 102. For example, the user experience management module 204 may use information on the current location of the user device 110 within the merchant premise 102 to provide information on offers and promotions on items close to the customer which are of interest to the customer. The user experience management module 204 may access the user data 230, for example to determine previous items purchased by the customer, the merchant premise data 240 to determine the location of those items or similar items, and may also access the promotion/offer data 250 to determine current offers and promotions on such items. The navigation module 206 is operable to assist the customer in navigating around the merchant premise 102, for example, to direct the customer to the location of a desired item using the information stored in the merchant premise data 240. The shopping cart module 208 is operable to determine and store information on the current shopping cart content of the customer's trolley or basket based on items identified by the computer vision system 220. The payment processing module 210 is operable to process payment transactions upon checkout. The payment processing module 210 may interact with the secure remote commerce server 150 to initiate payment transactions.

The computer vision system 220 is arranged to monitor the merchant premise 102 and identify objects selected by a customer and placed in their shopping basket or trolley. The user data 230 comprises data relating to users who are members of a loyalty scheme of the merchant. The user data 230 may comprise data relating to the user such as their name, address and contact details, it may also comprise demographic data such as their age, and gender, it may also comprise historical purchase data for the user. The merchant premise data 240 comprises data on the merchant premise such as the products offered for sale and the locations of the products within the merchant premise 102. The offer/promotion data 250 comprises indications of offers and promotions available in the merchant.

FIG. 3 a block diagram showing functional modules of a user identity management server according to an embodiment of the present invention. As shown in FIG. 3, the user identity management server 140 comprises an identity generation module 302. The module shown in FIG. 3 may be implemented as hardware, software or a combination of hardware and software. An example of a technical architecture of the user identity management server 130 is described in detail below with reference to FIG. 8.

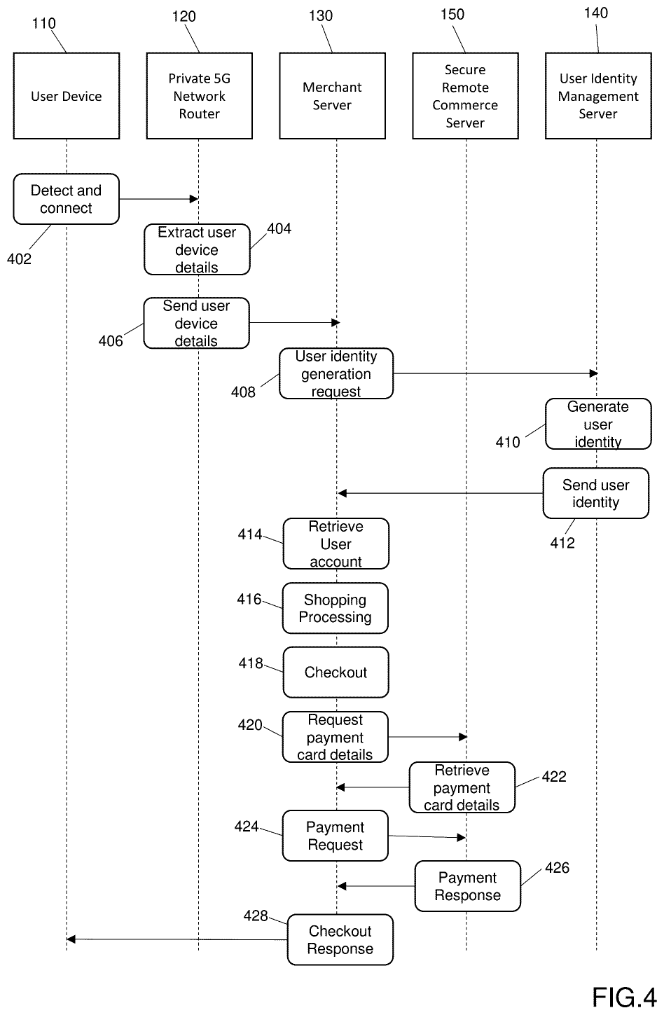

FIG. 4 is a message flow diagrams showing a user account processing method according to embodiments of the present invention. The processing shown in FIG. 4 is carried out in the system 100 shown in FIG. 1.

Initially, a user carrying the user device 110 enters the merchant premise 102, thus the user device 110 which is a 5G enabled device detects and connects to the private 5G network router 120 in step 402.

In step 404, the private 5G network router 120 extracts the user device details. The extracted details include a mobile number, a subscriber identity module (SIM) card number, and a device identifier such as an IMEI (International Mobile Equipment Identity) number of the user device 110.

In step 406, the private 5G network router 120 sends the user device details comprising the mobile number, SIM card number and IMEI number to the merchant server 130. After receiving the user details from the private 5G network router 120, in step 408, the merchant server 130 generates a user identity generation request. The user identity generation request comprises the mobile number, SIM card number and IMEI number for the user device 110. Following generation of the user identity generation request, the merchant server 130 sends the user identity generation request to the user identity management server 140.

In step 410, after receiving the user identity generation request, the user identity management server 140 generates a user identity using the mobile number, SIM card number and IMEI number for the user device 110. The user identity management server 140 uses a function which combines the mobile number, SIM card number and IMEI number for the user device 110 to generate the user identity. For example, the user identity management server 140 may use a hash function to combine the mobile number, SIM card number and IMEI number for the user device 110 to generate the user identity.

After generating the user identity in step 410, in step 412, the user identity management server 140 sends the user identity to the merchant server 130.

In step 414, the merchant server 130 uses the received user identity to retrieve user account details for the customer. For example, the user experience management module 204 of the merchant server 130 may look up user account details in the database storing user data 230 using the user identity. If in step 414, it is determined that there no account linked to the user identity, the merchant server 130 may send an invitation to the user device 110 via the private 5G network router 120. The invitation may allow the user to link an existing account with the user identity to open a new account and link the new account to the user identity.

In step 416, the merchant server 130 processes shopping by the customer. Step 416 may involve the computer vision system 220 identifying products picked up by the customer and these may be added to a shopping cart of the customer by the shopping cart module 208 of the merchant server 130.

The user experience management module 204 and the navigation module 206 of the merchant server 130 may be executed during the shopping processing. For example, the navigation module 206 may be executed to assist the customer in navigating around the merchant premise 102. The private 5G network router 120 may determine the location of the user device 110 within the merchant premise 102 using multiple antennas of the private 5G network router 120 to locate the user device 110. The navigation module 206 may determine locations of desired products from the merchant premise data 240 and direct the customer to those locations. The user experience module 204 may also use the location of the user device 110 within the merchant premise 102 and provide the customer with details of products for which offers and promotions are available. This processing may be carried out by the user experience management module 204 using the promotion/offer data 250.

Once the customer has completed shopping, they may move to the checkout area 104 of the merchant premise 102. The merchant server 130 may detect that the user device 110 has moved to the checkout area 104 and initiate the checkout in step 418. As mentioned above, the private 5G network router 120 may determine the location of the user device 110 and provide this location information to the merchant server 130.

Following the checkout in step 418, the payment processing module 210 of the merchant server 130 initiates payment in step 420. Step 420 comprises requesting payment card details from the secure remote commerce server 150. The request for payment card details may comprise an indication of the user identity generated for the user.

In step 422, the secure remote commerce server 150 retrieves payment card details associated with the user identity. The payment card details retrieved in step 422 may be indication of masked payment cards.

In step 424, after receiving the payment card details, the merchant server 130 generates a payment request which is sent to the secure remote commerce server 150.

Following step 424, the secure remote commerce server 150 processes a payment and upon successful completion of the payment, generates a payment response in step 426 which is sent to the merchant server 130.

In step 428, the merchant server 130 generates a checkout response indicating that the checkout has been successfully completed which is sent to the user device 110.

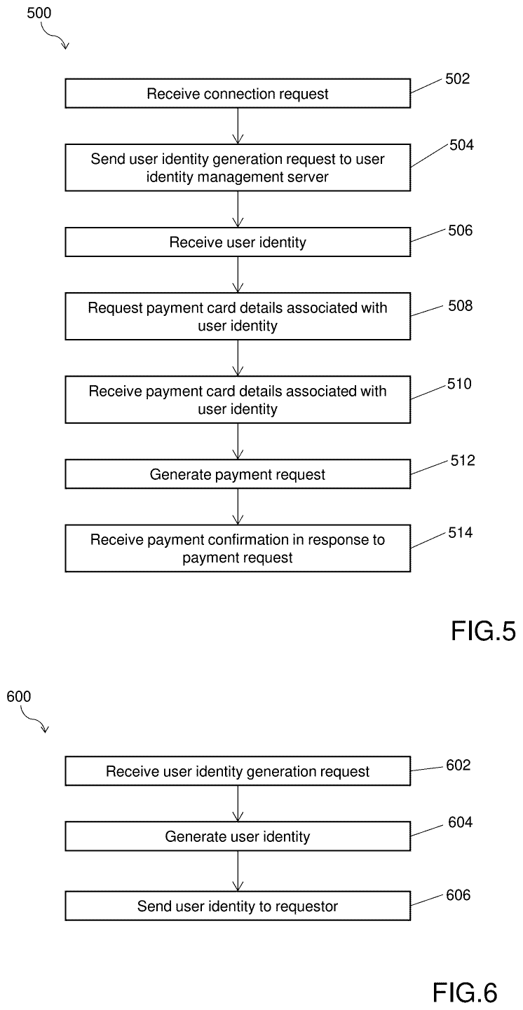

FIG. 5 is a flow chart showing a user account processing method according to embodiments of the present invention. The method 500 shown in FIG. 5 is carried out by the merchant server 130 shown in FIG. 2 and corresponds to the parts of the processing shown in FIG. 4 which are carried out by the merchant server 130.

In step 502, the user ID management module 202 of the merchant server 130 receives notification of a connection request from the private 5G network router 120. The connection request comprises an indication of a user identifier of a user, a subscriber identity module (SIM) number associated with the user and a device identifier of the user device 110. The user identifier may be the mobile telephone number of the user and the device identifier of the user device may be the international mobile equipment identity (IMEI) number of the user device 110.

In step 504, the user ID management module 202 of the merchant server 130 generates a user identity generation request and sends the user identity generation request to the user identity management server 140. The user identity generation request comprises an indication of the user identifier of the user (such as the mobile telephone number), an indication of the subscriber identity module (SIM) number associated with the user and an indication of the user device identifier (such as the IMEI number) of the user device 110.

Following step 504, the user identity management server 140 generates a user identity for the user. This process is described below with reference to FIG. 6.

In step 506, the user ID management module 202 of the merchant server 130 receives the user identity from the user identity management server 140.

In step 508, the payment processing module 210 of the merchant server 130 requests payment card details associated with the user from the secure remote commerce server 150. The secure remote commerce server 150 may store user payment card details and use the user identity derived from the user mobile number, the SIM number and the IMEI number of the user device 110 to identity users. Thus, the request for payment card details comprise the user identity.

In step 510, the payment processing module 210 of the merchant server 130 receives the payment card details associated with the user identity from the secure remote commerce server 150.

In step 512, the payment processing module 210 of the merchant server 130 generates a payment request which is sent to the secure remote commerce server 150.

In step 514, the payment processing module 210 of the merchant server 130 receives a payment confirmation from the secure remote commerce server 150.

FIG. 6 is a flow chart showing a user identity generation method according to an embodiment of the present invention. The method 600 shown in FIG. 6 is carried out by the user identity management server 140 shown in FIG. 3 and corresponds to the parts of the processing shown in FIG. 4 which are carried out by the user identity management server 140.

In step 602, the user identity management server 140 receives a user identity generation request. As described above, the user identity generation request comprises an indication of the user identifier of the user (such as the mobile telephone number), an indication of the subscriber identity module (SIM) number associated with the user and an indication of the user device identifier (such as the IMEI number) of the user device 110.

In step 604, the identity generation module 302 of the user identity management server 140 generates a user identity using the data in the user identity generation request. The user identity may be generated as the hash of the user mobile number, the SIM number and the IMEI number of the user device 110. The user identity generated by the user identity management server 140 may be in the form of characters, numbers or a combination of numbers and characters.

In some embodiments, the user identity management server 140 may comprise a database storing previously generated user identities. In such embodiments, upon receiving a user identity generation request, the user identity management server 140 checks the database and if a user identity has previously been generated for the user identifier of the user (such as the mobile telephone number), the indication of the subscriber identity module (SIM) number associated with the user and the indication of the user device identifier (such as the IMEI number) of the user device, then the user identity management server 140 may use a user identity stored in the database rather than re-generating the user identity.

In step 606, the user identity management server 140 sends the user identity to the merchant server 130.

FIG. 7 is a block diagram showing a technical architecture 700 of a merchant 130 server according to an embodiment of the present invention. Typically, the methods are implemented by a number of computers each having a data-processing unit. The block diagram as shown in FIG. 7 illustrates a technical architecture 700 of a computer which is suitable for implementing one or more embodiments herein.

The technical architecture 700 includes a processor 722 (which may be referred to as a central processor unit or CPU) that is in communication with memory devices including secondary storage 724 (such as disk drives), read only memory (ROM) 726, random access memory (RAM) 728. The processor 722 may be implemented as one or more CPU chips. The technical architecture 720 may further comprise input/output (I/O) devices 730, and network connectivity devices 732.

The secondary storage 724 is typically comprised of one or more disk drives or tape drives and is used for non-volatile storage of data and as an over-flow data storage device if RAM 728 is not large enough to hold all working data. Secondary storage 724 may be used to store programs which are loaded into RAM 728 when such programs are selected for execution. In this embodiment, the secondary storage 724 has a user ID management module module 702, a user experience management module 704, a navigation module 706, shopping cart module 708, and a payment processing module 710 comprising non-transitory instructions operative by the processor 722 to perform various operations of the method of the present disclosure. As depicted in FIG. 7, the modules 702-710 are distinct modules which perform respective functions implemented by the merchant server 130. It will be appreciated that the boundaries between these modules are exemplary only, and that alternative embodiments may merge modules or impose an alternative decomposition of functionality of modules. For example, the modules discussed herein may be decomposed into sub-modules to be executed as multiple computer processes, and, optionally, on multiple computers. Moreover, alternative embodiments may combine multiple instances of a particular module or sub-module. It will also be appreciated that, while a software implementation of the modules 702-710 is described herein, these may alternatively be implemented as one or more hardware modules (such as field-programmable gate array(s) or application-specific integrated circuit(s)) comprising circuitry which implements equivalent functionality to that implemented in software. The ROM 726 is used to store instructions and perhaps data which are read during program execution. The secondary storage 724, the RAM 728, and/or the ROM 726 may be referred to in some contexts as computer readable storage media and/or non-transitory computer readable media.

The I/O devices may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 732 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 732 may enable the processor 722 to communicate with the Internet or one or more intranets. With such a network connection, it is contemplated that the processor 722 might receive information from the network, or might output information to the network in the course of performing the method operations described herein. Such information, which is often represented as a sequence of instructions to be executed using processor 722, may be received from and outputted to the network, for example, in the form of a computer data signal embodied in a carrier wave.

The processor 722 executes instructions, codes, computer programs, scripts which it accesses from hard disk, floppy disk, optical disk (these various disk based systems may all be considered secondary storage 724), flash drive, ROM 726, RAM 728, or the network connectivity devices 732. While only one processor 722 is shown, multiple processors may be present. Thus, while instructions may be discussed as executed by a processor, the instructions may be executed simultaneously, serially, or otherwise executed by one or multiple processors.

It is understood that by programming and/or loading executable instructions onto the technical architecture 700, at least one of the CPU 722, the RAM 728, and the ROM 726 are changed, transforming the technical architecture 700 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

FIG. 8 is a block diagram showing a technical architecture 800 of a user identity management server 140 according to an embodiment of the present invention. Typically, the methods are implemented by a number of computers each having a data-processing unit. The block diagram as shown in FIG. 8 illustrates a technical architecture 800 of a computer which is suitable for implementing one or more embodiments herein.

The technical architecture 800 includes a processor 822 (which may be referred to as a central processor unit or CPU) that is in communication with memory devices including secondary storage 824 (such as disk drives), read only memory (ROM) 826, random access memory (RAM) 828. The processor 822 may be implemented as one or more CPU chips. The technical architecture 820 may further comprise input/output (I/O) devices 830, and network connectivity devices 832.

The secondary storage 824 is typically comprised of one or more disk drives or tape drives and is used for non-volatile storage of data and as an over-flow data storage device if RAM 828 is not large enough to hold all working data. Secondary storage 824 may be used to store programs which are loaded into RAM 828 when such programs are selected for execution. In this embodiment, the secondary storage 824 has a identity generation module 802 comprising non-transitory instructions operative by the processor 822 to perform various operations of the method of the present disclosure. As depicted in FIG. 8, the module 802 is a distinct module which performs respective functions implemented by the user identity management server 140. It will be appreciated that the boundaries between modules are exemplary only, and that alternative embodiments may merge modules or impose an alternative decomposition of functionality of modules. For example, the module discussed herein may be decomposed into sub-modules to be executed as multiple computer processes, and, optionally, on multiple computers. Moreover, alternative embodiments may combine multiple instances of a particular module or sub-module. It will also be appreciated that, while a software implementation of the module 802 is described herein, these may alternatively be implemented as one or more hardware modules (such as field-programmable gate array(s) or application-specific integrated circuit(s)) comprising circuitry which implements equivalent functionality to that implemented in software. The ROM 826 is used to store instructions and perhaps data which are read during program execution. The secondary storage 824, the RAM 828, and/or the ROM 826 may be referred to in some contexts as computer readable storage media and/or non-transitory computer readable media.

The I/O devices may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 832 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 832 may enable the processor 822 to communicate with the Internet or one or more intranets. With such a network connection, it is contemplated that the processor 822 might receive information from the network, or might output information to the network in the course of performing the method operations described herein. Such information, which is often represented as a sequence of instructions to be executed using processor 822, may be received from and outputted to the network, for example, in the form of a computer data signal embodied in a carrier wave.

The processor 822 executes instructions, codes, computer programs, scripts which it accesses from hard disk, floppy disk, optical disk (these various disk based systems may all be considered secondary storage 824), flash drive, ROM 826, RAM 828, or the network connectivity devices 832. While only one processor 822 is shown, multiple processors may be present. Thus, while instructions may be discussed as executed by a processor, the instructions may be executed simultaneously, serially, or otherwise executed by one or multiple processors.

It is understood that by programming and/or loading executable instructions onto the technical architecture 800, at least one of the CPU 822, the RAM 828, and the ROM 826 are changed, transforming the technical architecture 800 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Whilst the foregoing description has described exemplary embodiments, it will be understood by those skilled in the art that many variations of the embodiments can be made within the scope of the invention as defined by the claims. Moreover, features of one or more embodiments may be mixed and matched with features of one or more other embodiments.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, and as described, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And, again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the term “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112 (f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

### EXAMPLE EMBODIMENTS

Additional example embodiments are provided below.

Embodiment 1. A user account processing system, comprising: a processor, and a data storage device, data storage device storing computer program instructions operable to cause the processor to: receive a connection request from a user device, the connection request comprising a user identifier of a user, a subscriber identity module number associated with the user, and a device identifier of a device associated with the user; send a user identity generation request to a user identity management server; receive a user identity for the user from the user identity management server; request payment card details associated with the user identity from a payment card management system; receive payment card details associated with the user identity from the payment card management system; generate a payment request comprising the payment card details associated with the user identity; and receive payment confirmation in response to the payment request.

Embodiment 2. The user account processing system according to Embodiment 1, wherein the user identifier of a user comprises a mobile telephone number associated with the user.

Embodiment 3. The user account processing system according to Embodiment 1 or Embodiment 2, wherein the device identifier of the device associated with the user comprises an international mobile equipment identity number of the device associated with the user.

Embodiment 4. The user account processing system according to any preceding Embodiment, wherein the data storage device further stores instructions operable to cause the processor to receive an indication of a location of the user device within a merchant premise and wherein the payment request is generated in response to the location being in proximity to a checkout location or area.

Embodiment 5. The user account processing system according to any preceding Embodiment, wherein the data storage device further stores instructions operable to cause the processor to identify a user merchant account associated with the user from the user identity.

Embodiment 6. The user account processing system according to any one of Embodiments 1 to 4, wherein the data storage device further stores instructions operable to cause the processor to associate a user merchant account with the user identity.

Embodiment 7. The user account processing system according to Embodiment 6, wherein the data storage device further stores instructions operable to cause the processor to associate a user merchant account with the user identity by associating an existing user merchant account with the user identity.

Embodiment 8. The user account processing system according to Embodiment 6, wherein the data storage device further stores instructions operable to cause the processor to associate a user merchant account with the user identity by generating a new user merchant account.

Embodiment 9. A user identity generation system, comprising: a processor, and a data storage device, data storage device storing computer program instructions operable to cause the processor to: receive a user identity generation request from a requestor server, the user identity generation request comprising a user identifier of a user, a subscriber identity module number associated with the user, and a device identifier of a device associated with the user; generate a user identity for the user as a combination function of the user identifier of the user, the subscriber identity module number associated with the user, and the device identifier of the device associated with the user; and send the user identity for the user to the requestor server.

Embodiment 10. The user identity generation system according to Embodiment 9, wherein the user identifier of a user comprises a mobile telephone number associated with the user.

Embodiment 11. The user identity generation system according to Embodiment 9 or Embodiment 10, wherein the device identifier of the device associated with the user comprises an international mobile equipment identity number of the device associated with the user.

Embodiment 12. The user identity generation system according to any one of Embodiments 9 to 11, wherein the combination function is a hash function.

Embodiment 13. A user account processing method comprising: receiving a connection request from a user device, the connection request comprising a user identifier of a user, a subscriber identity module number associated with the user, and a device identifier of a device associated with the user; sending a user identity generation request to a user identity management server; receiving a user identity for the user from the user identity management server; requesting payment card details associated with the user identity from a payment card management system; receiving payment card details associated with the user identity from the payment card management system; generating a payment request comprising the payment card details associated with the user identity; and receiving payment confirmation in response to the payment request.

Embodiment 14. The method according to Embodiment 13, further comprising identifying a user merchant account associated with the user from the user identity.

Embodiment 15. The method according to any one of Embodiments 13 to 14, further comprising associating a user merchant account with the user identity.

Embodiment 16. A user identity generation method comprising: receiving a user identity generation request from a requestor server, the user identity generation request comprising a user identifier of a user, a subscriber identity module number associated with the user, and a device identifier of a device associated with the user; generating a user identity for the user as a combination function of the user identifier of the user, the subscriber identity module number associated with the user, and the device identifier of the device associated with the user; and sending the user identity for the user to the requestor server.

Embodiment 17. The method according to Embodiment 16, wherein the combination function is a hash function.

Embodiment 18. The method according to any one of Embodiment 13 to 17, wherein the user identifier of a user comprises a mobile telephone number associated with the user.

Embodiment 19. The method according to any one of Embodiments 13 to 18, wherein the device identifier of the device associated with the user comprises an international mobile equipment identity number of the device associated with the user.

Embodiment 20. A non-transitory computer readable medium carrying computer executable instructions which when executed on at least one processor cause the at least one processor to carry out a method according to any one of Embodiments 13 to 19.

What is claimed is:

1. A user account processing system, comprising: a processor, and a data storage device, data storage device storing computer program instructions operable to cause the processor to:
receive a connection request from a user device, the connection request comprising a user identifier of a user, a subscriber identity module number associated with the user, and a device identifier of a device associated with the user;
send a user identity generation request to a user identity management server;
receive a user identity for the user from the user identity management server;
request payment card details associated with the user identity from a payment card management system;
receive payment card details associated with the user identity from the payment card management system;
generate a payment request comprising the payment card details associated with the user identity; and
receive payment confirmation in response to the payment request.

2. The user account processing system according to claim 1, wherein the user identifier of a user comprises a mobile telephone number associated with the user.

3. The user account processing system according to claim 1, wherein the device identifier of the device associated with the user comprises an international mobile equipment identity number of the device associated with the user.

4. The user account processing system according to claim 1, wherein the data storage device further stores instructions operable to cause the processor to receive an indication of a location of the user device within a merchant premise and wherein the payment request is generated in response to the location being in proximity to a checkout location or area.

5. The user account processing system according to claim 1, wherein the data storage device further stores instructions operable to cause the processor to identify a user merchant account associated with the user from the user identity.

6. The user account processing system according to claim 1, wherein the data storage device further stores instructions operable to cause the processor to associate a user merchant account with the user identity.

7. The user account processing system according to claim 6, wherein the data storage device further stores instructions operable to cause the processor to associate a user merchant account with the user identity by associating an existing user merchant account with the user identity.

8. The user account processing system according to claim 6, wherein the data storage device further stores instructions operable to cause the processor to associate a user merchant account with the user identity by generating a new user merchant account.

9. A user account processing method comprising:
receiving a connection request from a user device, the connection request comprising a user identifier of a user, a subscriber identity module number associated with the user, and a device identifier of a device associated with the user;
sending a user identity generation request to a user identity management server;
receiving a user identity for the user from the user identity management server;
requesting payment card details associated with the user identity from a payment card management system;
receiving payment card details associated with the user identity from the payment card management system;
generating a payment request comprising the payment card details associated with the user identity; and
receiving payment confirmation in response to the payment request.

10. The method according to claim 9, further comprising identifying a user merchant account associated with the user from the user identity.

11. The method according to claim 9, further comprising associating a user merchant account with the user identity.

12. The method according to claim 9, further comprising:
receiving the user identity generation request from a requestor server, the user identity generation request comprising the user identifier of the user, the subscriber identity module number associated with the user, and the device identifier of the device associated with the user;
generating the user identity for the user as a combination function of the user identifier of the user, the subscriber identity module number associated with the user, and the device identifier of the device associated with the user; and
sending the user identity for the user to the requestor server.

13. The method according to claim 12, wherein the combination function is a hash function.

14. The method according to claim 12, wherein the user identifier of a user comprises a mobile telephone number associated with the user.

15. The method according to claim 12, wherein the device identifier of the device associated with the user comprises an international mobile equipment identity number of the device associated with the user.
